(19) United States
(12) Patent Application Publication
(10) Pub. No.: US 2006/0059017 A1
(43) Pub. Date: Mar. 16, 2006

(54) Method and system for performing post-marketing surveillance of drugs using pharmacy-based cohorts

(75) Inventors: Carol Louik, Brookline, MA (US); Allen A. Mitchell, Wellesley, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: The Trustees of Boston University

(21) Appl. No.: 11/213,332

(22) Filed: Aug. 26, 2005

Related U.S. Application Data
(60) Provisional application No. 60/605,059, filed on Aug. 27, 2004.

(51) Int. Cl. G06Q 10/00

(52) U.S. Cl. 705/2

(57) ABSTRACT

A database contains confidential patient information. A researcher conducting a post-marketing study provides selection criteria to a maintainer of the database. The maintainer uses the selection criteria to select a cohort of potential post-marketing study subjects. The maintainer sends a questionnaire to each subject in the cohort. Optionally, the maintainer keeps a list of the identities of the subjects in the cohort. Subjects who choose to participate in the post-marketing study fill-in their questionnaires and return the questionnaires directly to the researcher. If the subjects choose to identify themselves to the researcher, the researcher can contact the subjects directly for follow-on research. Optionally, the researcher notifies the maintainer of the identities of subjects who return questionnaires, and the maintainer identifies subjects who do not return questionnaires and sends further questionnaires to these subjects. The maintainer informs the researcher of the number and characteristics (such as age, sex and zip code) of subjects in the cohort and optionally of subjects who do not return questionnaires, without revealing the identities or other confidential information of the subjects. The researcher uses the number and characteristics of the subjects to evaluate various aspects of the post-marketing study.

### CROSS REFERENCE TO RELATED APPLICATIONS

This application claims the benefit of U.S. Provisional Patent Application No. 60/605,059, filed Aug. 27, 2004, titled “A Method Of Performing Post-Marketing Surveillance Of Drugs Using Pharmacy-Based Cohorts.”

### STATEMENT REGARDING FEDERALLY SPONSORED RESEARCH OR DEVELOPMENT

(Not applicable)

### BACKGROUND OF THE INVENTION

The present invention relates to identifying a cohort of study members in a database without violating confidentiality provisions of the database and, more particularly, to enabling a researcher to obtain information about participating and non-participating members of the cohort.

Before a drug is approved to be marketed and prescribed, the drug must pass a government-prescribed approval process. These “pre-marketing” studies (including those commonly referred to as “clinical trials”) are rigorous; however the full range of a drug's risks cannot be evaluated until after the drug is approved, that is, while the drug is marketed and used in real-world clinical practice. Consequently, “post-marketing” studies are typically conducted to further evaluate the drug.

Pre-marketing studies typically involve only small numbers of carefully screened and otherwise healthy subjects who are treated for only short periods of time and monitored for only short-term outcomes. Subpopulations, such as children, pregnant women and elderly people, have traditionally been excluded. These and other limitations in pre-marketing studies make it necessary to conduct post-marketing studies to explore both the efficacy and risks of medications, as the medications are used in more realistic settings.

When post-marketing cohort studies of specific drugs are undertaken, a major issue is identifying and recruiting a representative population of drug users. Approaches that rely on physicians or pharmacists to recruit subjects have met with varying degrees of success. However, because they depend on active involvement of a party, who may be distracted by other professional responsibilities at the time of patient contact, such cohorts have been subject to the possibility of selection bias. Furthermore, it may be impossible to determine whether such bias is present, because information on the total population approached to participate in the study is rarely available. Without information that allows one to compare people who choose to participate with people who decline to participate in a study, a researcher cannot accurately ascertain if the participants are representative of the target audience for a drug being studied.

The advent of large, chain pharmacies with centralized prescription records has made it theoretically possible to identify large numbers of eligible study subjects, without relying on intervention by individual health practitioners. These data files also provide the opportunity to identify the entire target population and to assess representativeness of the participants, with respect to characteristics of interest, such as age, sex and medical history. However, while these data files contain confidential patient data, which would be helpful to a researcher conducting a post-marketing study, privacy regulations prohibit access to this data by most such researchers.

### BRIEF SUMMARY OF THE INVENTION

A method and system for performing post-marketing surveillance of drugs using pharmacy-based cohorts, without violating privacy regulations, is disclosed. The disclosed method and system assemble a cohort of subjects exposed to one or more prescription medications, without relying on individual health practitioners to recruit patients. The entire target population is identified. Consequently, unlike prior-art methodologies, participants and non-participants can be counted and characterized. A researcher can assess the characteristics of the participants in a study, relative to non-participants, and thus the researcher can assess the validity of the study.

### BRIEF DESCRIPTION OF THE SEVERAL VIEWS OF THE DRAWINGS

These and other features, advantages, aspects and embodiments of the present invention will become more apparent to those skilled in the art from the following Detailed Description of the Invention, in conjunction with the Drawings, of which:

FIG. 1 is a block diagram depicting operation of one embodiment of the present invention; and

FIGS. 2A and 2B contain a flowchart describing operation of one embodiment of the present invention.

### DETAILED DESCRIPTION OF THE INVENTION

The contents of U.S. Provisional Patent Application No. 60/605,059, filed Aug. 27, 2004, titled “A Method Of Performing Post-Marketing Surveillance Of Drugs Using Pharmacy-Based Cohorts,” are hereby incorporated by reference.

To maintain confidentiality of patient data, researchers conducting post-marketing studies do not directly access the confidential patient data. Instead, the researchers provide selection criteria to maintainers of the confidential patient data. (For simplicity, the maintainers of the confidential patient data will be referred to as “maintainers.”) For example, the selection criteria can be provided to one or more large pharmacy chains. The maintainers use the selection criteria to select a cohort of potential post-marketing study subjects.

The researchers can also provide a questionnaire to the maintainers, and the maintainers can send copies of the questionnaire to the subjects in the cohort. Optionally, the maintainers keep lists of the identities of the subjects in the cohort. Subjects who choose to participate in the post-marketing study fill in their questionnaires and return the filled-in questionnaires directly to the researchers. If the subjects choose to identify themselves to the researchers, the researchers can contact the subjects directly for follow-on research.

The maintainers inform the researchers of the number of subjects in the cohort, without revealing the identities or other confidential information of the subjects. The maintainers can also provide information about characteristics of the subjects who return questionnaires and information about characteristics of subjects who do not return questionnaires, without revealing any confidential information. The researchers use the number of subjects in the cohort (i.e. the number of subjects who were sent questionnaires) and the characteristics of the participants and non-participants to evaluate various aspects of the post-marketing study. For example, the number and characteristics of subjects who return questionnaires can be compared to the number and characteristics of subjects in the cohort or subjects who do not return questionnaires to determine a recruitment rate, the validity of the post-marketing study or the effectiveness of the questionnaires (or any incentives, etc. that were offered to the subjects) at inducing the subjects to participate in the post-marketing study.

Optionally, the researchers notify the maintainers of the identities of the subjects who return questionnaires. The maintainers have the identities of the subjects in the cohort. Thus, the maintainers can identify the subjects who do not return questionnaires, and the maintainers can send further questionnaires to the subjects who do not return the first questionnaires. Furthermore, the maintainers can provide information, such as age, sex and zip code, to the researchers regarding participants and non-participants (i.e., subjects who return questionnaires and subjects who do not return questionnaires), without identifying the non-participants.

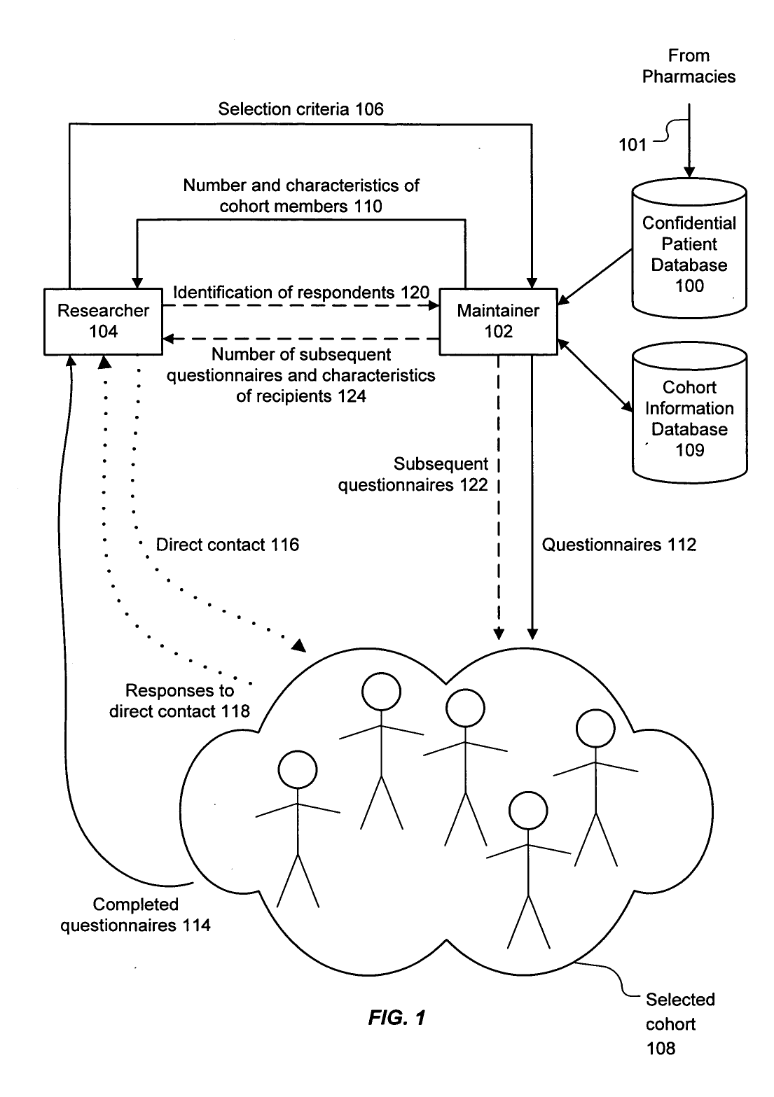

FIG. 1 is a block diagram depicting operation of one embodiment of the present invention. A database 100 contains patient information. For example, the database can include information about customers of a pharmacy, a chain of pharmacies, a combination of unrelated pharmacies or a combination thereof. The database includes names and addresses of the customers, along with information about prescription drugs, non-prescription drugs and/or other products purchased by the customers. Optionally, the database can include other information about the customers, such as age, sex, ZIP code, medical history, family information, preferences and the like. The database 100 can be an aggregation of databases created and/or maintained by more than one organization.

The database 100 is preferably implemented as a computerized database using conventional computer hardware, operating system and database software. As indicated at 101, information is automatically collected, such as by cash registers in pharmacies, and the information is transferred and stored in the database 100 using well-known techniques.

A maintainer 102 maintains the database 100. For example, the maintainer can be the pharmacy or chain of pharmacies described above. In the case of an aggregated database, the maintainer 102 can be a collection of separate maintainers of the respective separate databases. Although the exemplary database 100 and the maintainer 102 are described in the context of one or more pharmacies, other types of organizations are acceptable. For example, the database 100 can contain patient information from a physician, hospital, clinic, school, insurance provider or other organization. The maintainer 102 need not be health-related. For example, a life insurance provider can be the maintainer 102. Similarly, the people whose information is stored in the database 100 need not be patients. For example, the people can be students, insureds or any collection of people.

The information in the database 100 is typically confidential, and release of the information beyond a predefined set of entities is typically prohibited by law. The maintainer 102 is within the predefined set of entities that is permitted to access the database 100. Optionally, all or part of the information in the database 100 is not protected by law; however, release of all or part of the information beyond a predefined set of entities may be prohibited by contract or simply by a desire by the maintainer 102 to limit dissemination of the information.

A researcher 104, such as a researcher at an analysis facility, desiring to conduct a post-marketing study involving some or all of the people represented by the data in the database 100 supplies selection criteria 106 to the maintainer 102, and the maintainer 102 uses the selection criteria 106 to select a cohort 108 of people who meet the selection criteria. For example, the selection criteria can be all persons who have filled prescriptions for drug A or drug B at a pharmacy of chain C within the past 18 months. Other exemplary selection criteria are listed in Table 1. The selection criteria can be any combination, including any Boolean combination, of the information stored in the database 100. The selection criteria 106 can be communicated electronically or by any other appropriate method from the researcher 104 to the maintainer 102. The maintainer 102 can use facilities included in the database software or other software to select records in the database 100 that match the selection criteria. The process of communicating the selection criteria 106 and selecting the matching records in the database 100 can be fully automatic or involve human interaction.

TABLE 1
Exemplary Selection Criteria

Sex
Age
Geographic Region
Other Prescription Medications
Physician
Insurance Status

The maintainer 102 stores information about members of the cohort 108 in a cohort information database 109. This information includes some or all of the information from the confidential patient database 100 related to the members of the cohort 108. Although a separate database is shown in FIG. 1, the cohort information database 109 can be combined with the confidential patient database 100. For example, a flag or code can be used to identify records in the confidential patient database 100 that are associated with members of the cohort 108 and, optionally, which of potentially several cohorts (not shown) the record is associated with.

The selection criteria can also specify a maximum number of members in the cohort. In this case, if the remaining selection criteria select more than the specified maximum number of members, a number of the potential members that otherwise meet the selection criteria are not included in the cohort, such that the cohort 108 contains no more than the specified maximum number of members. The members that are not included can be randomly selected. Optionally, the cohort information database 109 can include information about whether particular records in the confidential patient database 100 (that otherwise meet the selection criteria) are or are not included in the cohort 108 due to the maximum number of cohort members.

Optionally, the selection criteria can specify random selection of the members of the cohort 108 from the database 100, without specifying other selection criteria. As in the previous case, a maximum number of members can be specified. Optionally, the cohort information database 109 can include information about the randomly selected members of the cohort 108.

The size (and, optionally, characteristics) 110 of the cohort 108 is provided to the researcher 104, as described in more detail below.

The researcher 104 provides information about the post-marketing study to the maintainer 102. This information can include a questionnaire to be sent to the members of the cohort 108. The questionnaire can include a cover letter, an explanation of the post-marketing study, an incentive (such as an offer of a gift coupon) to participate in the post-marketing study and/or other information. The questionnaire (or subsequent interactions, described below, between the researcher 104 and the members of the cohort 108) can be designed to ascertain information that enables the researcher 104 to evaluate a prescription or non-prescription drug, a medical procedure or other treatment or other data. For example, the questionnaire can include questions regarding symptoms, past treatments, other medications used by the member and demographics. Such an evaluation can include effectiveness, compliance, safety, satisfaction and/or other criteria.

Optionally, prior to sending the questionnaires 112, the maintainer 102 contacts the people who meet the selection criteria (“potential members”) to ask each potential member if he or she wishes to participate in the post-marketing study. This contact can be via telephone, postal mail, e-mail or any other suitable form of contact for combination thereof. The researcher 104 can provide a script or form letter to the maintainer 102 to be used during this contact. For example, this script or form letter can describe the post-marketing study. Optionally, during the contacts, the maintainer 102 can offer the incentives described above to the potential members in an effort to induce the potential members to participate in the post-marketing study. For each potential member who responds positively, i.e. who wishes to participate in the post-marketing study, the maintainer 102 includes the potential member in the cohort 108 and sends the questionnaire 112 to the member.

Optionally, the researcher 104 also provides secondary selection criteria (not shown) to the maintainer 102. The secondary selection criteria typically include criteria for which there is no corresponding data in the database 100. Exemplary secondary selection criteria are listed in Table 2. As with the (primary) selection criteria described above, combinations, including Boolean combinations, of secondary selection criteria can be used.

The maintainer 102 determines if the contacted potential member matches the secondary selection criteria by asking appropriate questions or by noting comments or answers given by the contacted potential member of the cohort. Potential members who meet the secondary selection criteria are made members of the cohort 108, and questionnaires 112 are sent to the members of the cohort 108.

Optionally, information about which potential members meet the secondary selection criteria and/or information about which potential members do not meet the secondary selection criteria is stored in the cohort information database 109. In addition, the answers and comments from each potential member (or from only the members who meet the secondary criteria) are entered into the cohort information database 100. Collectively, information about the members of the cohort 108 (and optionally potential members who are not included in the cohort 108, such as because they do not meet the secondary selection criteria) constitutes characteristics of the cohort 108. For example, these characteristics can include such items as the number of: men, women, people of various ages, people who live within various ZIP codes or other geographic areas, people who take or have taken various drugs and people who have or have had various medical conditions. Other exemplary characteristics are listed in Tables 1 and 2. The maintainer 102 sends the characteristics 110 to the researcher 104.

TABLE 2
Exemplary Secondary Selection Criteria

Any Medical History Item
Marital Status
Race/Ethnicity
Occupation
Smoking History
Alcohol Consumption
Household Size
Physician Specialty
Education
Household Income
Non-Prescription Medications
Use of Contraceptives
Vitamins or Herbal Supplement Use

Some number of the members of the cohort 108 complete the questionnaires 112 and send the completed questionnaires 114 to the researcher 104. Typically, the questionnaires 112 ask for contact or other identifying information. Optionally, if a member of the cohort 108 provides this information, the researcher 104 can directly contact 116 the member of the cohort 108 to ask additional questions, study the member over a period of time or otherwise conduct further research. This direct contact 116 can be via telephone, postal mail, e-mail or any other suitable form of contact or a combination thereof. This direct contact 116 does not violate the confidentiality of the database 100, because the contact or other identifying information used to contact a member is voluntarily provided by the member, i.e., the member gives his or her consent to provide the information to the researcher 104. The contacted member of the cohort 108 can respond 118 to the researcher 104 via the same or a different form of contact than the form of contact used by the researcher 104. Typically, the researcher 104 takes steps to maintain the confidentiality of the information provided by the members of the cohort 108.

Optionally, the researcher 104 identifies 120 to the maintainer 102 the members of the cohort 108 who send completed questionnaires 114, or at least their consent, to the researcher. The maintainer 102 uses this information and information in the cohort information database 109 to identify the members of the cohort 108 who did not send completed questionnaires 114 to the researcher 104. The maintainer 102 sends subsequent questionnaires 122 to the members of the cohort 108 who did not send completed questionnaires 114 to the researcher 104. The maintainer 102 also sends the number 124 of the subsequent questionnaires 122, as well as information about the members to whom the subsequent questionnaires are sent, to the researcher 104. This process can be repeated a number of times. The subsequent questionnaires 122 can be the same as, or different than, the original questionnaires 112.

Unlike prior art methods, in the presently disclosed method and system, the maintainer 102 can use the information in the cohort information database 109 to send information about characteristics of the members of the cohort 108 who did and who did not send completed questionnaires 114 to the researcher 104. For example; this information can include the number of men, women, married members, members aged 18-24, etc., who did and who did not send completed questionnaires 114 to the researcher 104. The researcher 104 can use this information to compare the characteristics of the members of the cohort 108 who sent completed questionnaires 114 (i.e., respondents) to the characteristics of the members who did not send completed questionnaires (i.e., non-respondents) to ascertain if the respondent population is representative of a target population. For example, in a study of a weigh loss drug, in which the response rate is 60%, if the average age of the respondents is 70 years and the average age of the non-respondents is 40 years, the results could not be generalized to the target population, due to the significant difference in the ages of the respondents and the non-respondents.

The researcher 104 is provided with the size of the cohort 108. That is, the researcher 104 is provided with the number of records in the confidential patient database 100 that meet the primary and/or secondary selection criteria and optionally information about participants and non-participants. Alternatively or in addition, the researcher 104 is provided with the number of questionnaires 112 (and optionally the number of subsequent questionnaires 122) that are sent to members of the cohort 108 and information about these members. The number of questionnaires 112 can be different than the number of records in the confidential patient database 100 that meet the primary and/or secondary selection criteria, because a maximum number of members of the cohort 108 may have been specified. Similarly, the number of questionnaires 112 can be different than the number of records in the confidential patient database 100 that meet the primary selection criteria, because the secondary selection criteria reduced the number of eligible members in the cohort 108.

Thus, the researcher 104 can calculate a recruitment rate or a proportion of the members of the cohort 108 that completed questionnaires 114. For this calculation, the size of the cohort 108 can be the number of questionnaires 112 that were sent, the number of records in the confidential patient database 100 that meet the primary selection criteria, the number of records in the confidential patient database 100 that meet the primary and secondary selection criteria, any of these numbers limited by the specified maximum size of the cohort, any of these numbers adjusted by the number of subsequent questionnaires 124 that were sent or any combination thereof. These numbers, or any one of them, are referred to herein as a “base population.”

The recruitment rate or proportion of the members of the cohort 108 that completed questionnaires 114 or other calculations can involve the base population and can be performed by the researcher 104, without violating the confidentiality of the confidential patient database 100.

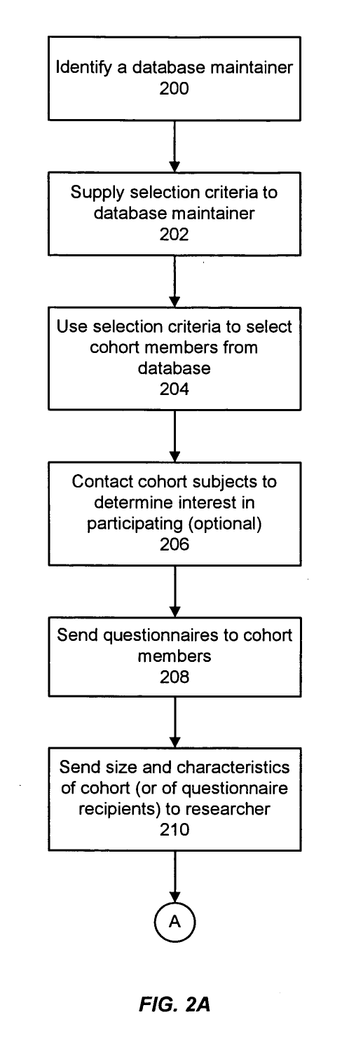

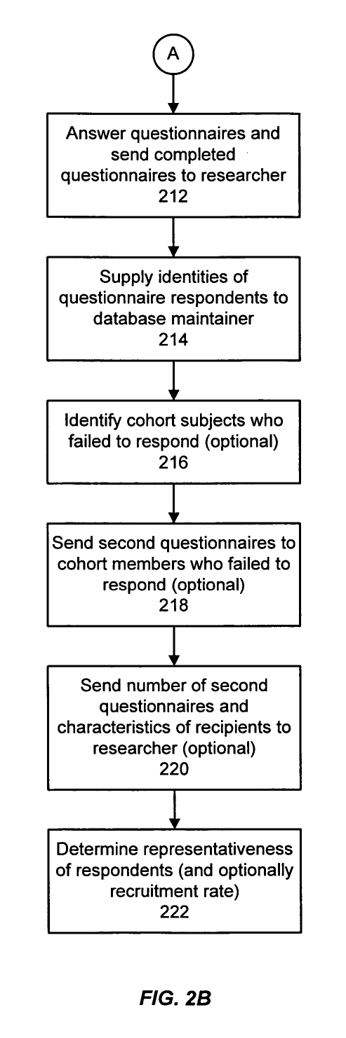

FIGS. 2A and 2B contain a flowchart describing operation of one embodiment of the present invention. At 200, a database maintainer is identified. For example, a drug provider having multiple drug outlets where a drug is made available to users is identified. At 202, selection criteria are provided, such as to a maintainer of the database. At 204, the selection criteria are used to select cohort members from the database. Optionally, at 206, potential members of the cohort are contacted to determine their interest in participating in a study.

At 208, questionnaires are sent to the members of the cohort. At 210, the size (and optionally characteristics) of the cohort (or the number of questionnaires sent to the members of the cohort) is sent to a researcher.

At 212, the members of the cohort who complete the questionnaires send the completed questionnaires to the researcher. At 214, the identities of the members who sent completed questionnaires are provided to the database maintainer.

Optionally, at 216, identities of the members of the cohort who failed to send completed questionnaires are determined, such as by the maintainer. Optionally, at 218, further questionnaires are sent to the members of the cohort who failed to send completed questionnaires to the researcher. Optionally, at 220, the number of further questionnaires (and optionally characteristics of the recipients) is sent to the researcher.

At 222, a recruitment rate is determined. Optionally, other numbers and/or characteristics are calculated and/or compared. For example, participants and non-participants (or numbers thereof) can be compared according to age, sex and/or location to determine the representativeness of the respondents to a target population. Thus, a researcher can ascertain the characteristics of non-respondents, without violating confidentiality provisions of a database of potential cohort members.

While the invention has been described through the above-described exemplary embodiments, it will be understood by those of ordinary skill in the art that modifications to, and variations of, the illustrated embodiments can be made without departing from the inventive concepts disclosed herein. For example, while the invention has been described in the context of conducting post-marketing studies for drugs, the invention can be used to identify potential subjects in pre-marketing clinical trials. Furthermore, the invention can be used in non-drug related contexts, such as in conducting studies of students or life or automobile insurance customers. In addition, embodiments that include combinations and sub-combinations of the disclosed features are possible. Accordingly, the invention should not be viewed as limited, except by the scope and spirit of the appended claims.

What is claimed is:

1. A method for creating a drug evaluation indicating one or more of its effectiveness, compliance, safety, satisfaction and other criteria of the prescription or non-prescription drug, comprising:
identifying a drug provider having multiple drug outlets where a drug is available to users;
querying at least some of the users who have purchased the drug from at least one of the multiple outlets to determine a willingness of the at least some of the users to participate in a study;
receiving at an analysis facility responses of willing users; and
analyzing the responses for determining the drug evaluation.

2. The method of claim 1, further comprising providing to the analysis facility a number of users queried to determine the willingness to participate in the study.

3. The method of claim 2, wherein analyzing the responses comprises using the number of users queried to determine the willingness to participate in the study.

4. The method of claim 2, further comprising calculating a recruitment rate using the number of users queried to determine the willingness to participate in the study.

5. The method of claim 1, further comprising providing to the analysis facility a number of participants.

6. The method of claim 1, further comprising developing or having developed a database of users of the drug from a plurality of the multiple drug outlets, the users having purchased the drug within a predetermined period of time.

7. The method of claim 1, further comprising developing or having developed a database of users of the drug who have returned the questionnaire to the analysis facility and/or completed an interview.

8. The method of claim 1, further comprising offering a financial incentive to users contacted.

9. The method of claim 1, further comprising including maintaining security of user identity against viewing by others, other than at the analysis facility.

10. The method of claim 1, further comprising obtaining information via questionnaire and/or interview of symptoms, past treatments, other medication use and/or demographic information related to the drug.

11. The method of claim 1, further comprising maintaining patient confidentiality until receipt of a questionnaire and/or interview results at the analysis facility.

12. The method of claim 1, further including comparing a number of participants and a number of non-participants.

13. The method of claim 12, wherein the number of participants and the number of non-participants is compared according to age, sex and/or location.

14. A database of users and/or evaluations created according to claim 1.
